(19) United States
(12) Patent Application Publication
(10) Pub. No.: US 2009/0044870 A1
(43) Pub. Date: Feb. 19, 2009

(54) DEVICE FOR SECURING A PUMP INLET

(76) Inventor: Walter Thomas Myers, JR., Magnolia, TX (US)

Correspondence Address: Walter Thomas Myers Jr., 30206 Greenwood St., Magnolia, TX, 77355, US

(21) Appl. No.: 12/178,207

(22) Filed: Jul. 23, 2008

Related U.S. Application Data
(60) Provisional application No. 60/965,160, filed on Aug. 17, 2007.

(51) Int. Cl. F16P 1/00

(52) U.S. Cl. 137/377

(57) ABSTRACT

Exemplary embodiments of the present invention disclosed herein relate to a device for securing an inlet of a pump. One exemplary embodiment of the present invention comprises at least two hose mounts connected to each other and a securing mechanism that is adapted to secure a hose between the at least two hose mounts, the hose comprising the inlet of the pump. In addition, an exemplary embodiment of the present invention may comprise a plurality of legs extending from the at least two hose mounts, the legs being adapted to hold the inlet in a fixed position relative to a source of water.

### CROSS-REFERENCE TO RELATED APPLICATION

This application claims priority of U.S. Provisional Patent Application Ser. No. 60/965,160, filed Aug. 17, 2007 entitled “Device Attaching to a Centrifugal Pump Suction Hose Protecting the Foot Valve from Debris” by Walter T. Myers, Jr., the contents of which are incorporated by reference as though fully set forth herein.

### BACKGROUND

Firefighters work with centrifugal pumps and use standing or moving bodies of water to battle wildfires. Firefighters usually have to stand in the water to secure a pump inlet such as a foot valve as well as the center of a suction hose connected to the pump inlet with locally obtained props such as rocks and tree limbs. As the pressure builds in the suction hose, the props could loosen causing damage to the foot valve or injury to the person. As the foot valve is typically disposed in sediment, small foreign material may enter the foot valve which could cause the pump to detonate. A device that secures a pump inlet in a manner that reduces intrusion of debris is desirable.

### BRIEF DESCRIPTION OF THE DRAWINGS

Certain exemplary embodiments are described in the following detailed description and in reference to the drawings, in which:

FIG. 1 is an exploded view of a device for preventing intrusion of debris into a pump according to an exemplary embodiment of the present invention;

FIG. 2 is a perspective view in partial cross-section of a device for preventing intrusion of debris into a pump according to an exemplary embodiment of the present invention;

FIG. 3 is a perspective view of a device for preventing intrusion of debris into a pump, the device including a swing bolt according to an exemplary embodiment of the present invention;

FIG. 4 is an exploded view showing the use of a swing bolt according to an exemplary embodiment of the present invention;

FIG. 5 is a perspective view of a device for preventing intrusion of debris into a pump, the device including left and right hose mounts according to an exemplary embodiment of the present invention;

FIG. 6 is a top view of left and right hose mounts according to an exemplary embodiment of the present invention;

FIG. 7 is a top view of a ball member having a recessed bolt cavity according to an exemplary embodiment of the present invention;

FIG. 8 is a bottom view of a ball member having a circular recessed ball mount according to an exemplary embodiment of the present invention; and

FIG. 9 is a perspective view of a device for preventing intrusion of debris into a pump according to an exemplary embodiment of the present invention.

### DETAILED DESCRIPTION OF SPECIFIC EMBODIMENTS

In accordance with an exemplary embodiment of the present invention, a device attaches to a centrifugal pump suction hose to protect a pump inlet such as a foot valve from debris during operation. Moreover, an exemplary embodiment of the present invention may dispose the foot valve away from local sediment by holding the foot valve in a fixed position relative to a source of water. In so doing, occurrences of pump detonation may be reduced. Exemplary embodiments of the present invention may allow users to operate pumps while keeping the feet of the user relatively dry, reducing occurrences of blisters. As an additional advantage, an exemplary embodiment of the present invention may desirably reduce swaying of a suction hose and foot valve. Swaying of the hose during operation is generally undesirable because it may result in damage to equipment or personal injury. In addition, an exemplary embodiment of the present invention saves set-up time because the user does not need to spend time looking for local props such as rocks and tree limbs to hold a pump inlet in place. This additionally prevents environmental damage caused by removal of props from their original location.

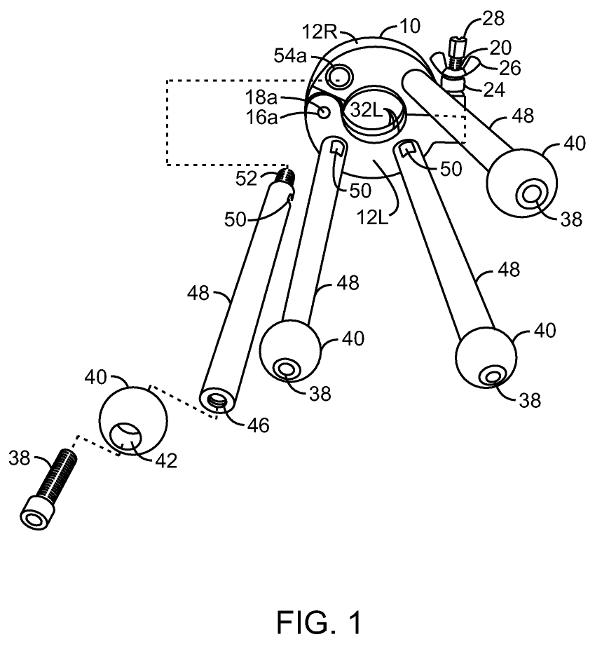

FIG. 1 is an exploded view of a device for preventing intrusion of debris into a pump according to an exemplary embodiment of the present invention. The device is generally referred to by the reference number 10. An exemplary embodiment of the present invention may be desirably attached to a centrifugal pump suction hose to protect a pump inlet such as a foot valve from debris and the like.

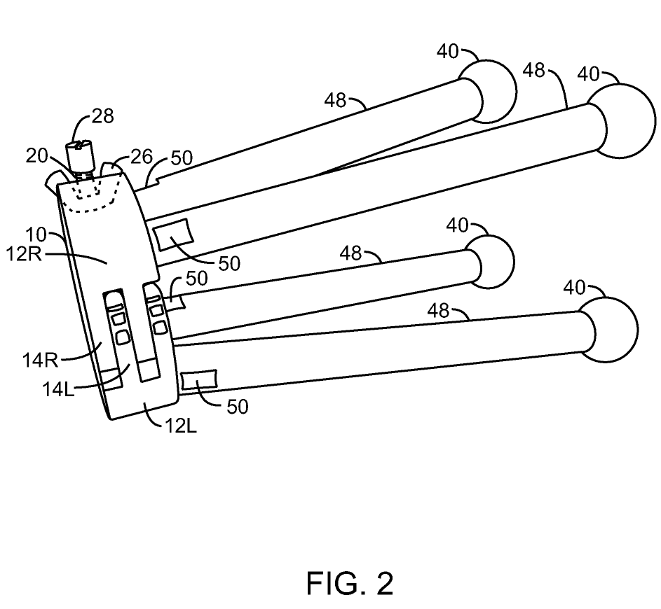

The device 10 includes a left hose mount 12L and a right hose mount 12R. The left hose mount 12L and the right hose mount 12R are connected via a left hinge 14L and a right hinge 14R (see FIG. 2). The left hinge 14L and the right hinge 14R are connected via a stationary round pin 18a, which is disposed within a cylindrical cavity 16a that extends through the left hinge 14L and the right hinge 14R.

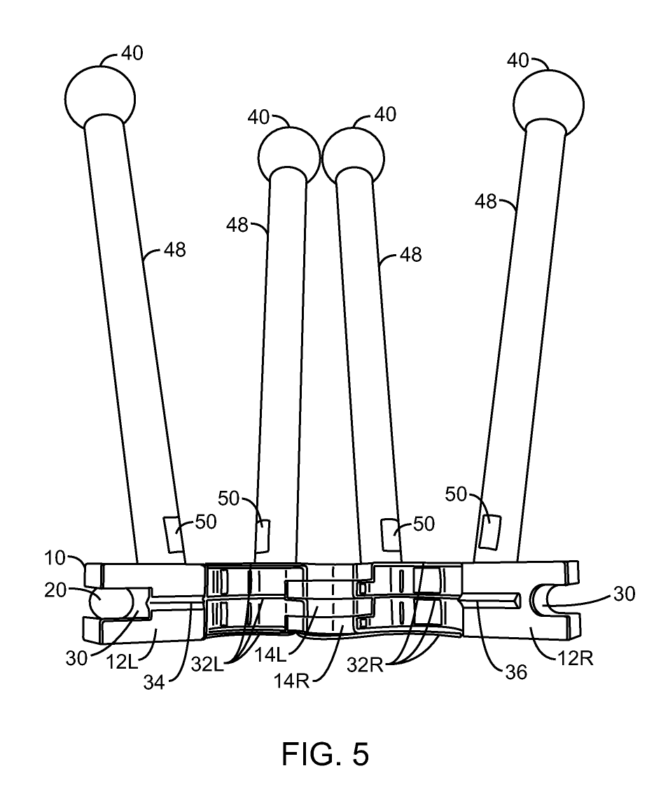

The left hose mount 12L has disposed therein a cylindrical cavity 16b that is adapted to receive a stationary round pin 18b (see FIG. 4). The stationary round pin 18b is adapted to secure a swing bolt 20. The swing bolt 20 extends through grooves 30 in the left hose mount 12L and the right hose mount 12R (see FIG. 5). In one exemplary embodiment of the present invention, the grooves 30 may comprise a vertical half-circular channel. A wing nut 26 is disposed on the swing bolt 20. In the exemplary embodiment shown in FIG. 1, a spacer 24 is disposed on the swing bolt 20 between the wing nut 26 and the right hose mount 12R. A spacer indention 22 may be disposed within the right hose mount 12R to accommodate the spacer 24. A cap 28 may be secured to the end of the swing bolt 20 to prevent removal and loss of the wing nut 26. Those of ordinary skill in the art will appreciate that pressure may be exerted on a hose disposed between the left hose mount 12L and the right hose mount 12R by tightening the wing nut 26 on the swing bolt 20.

In one exemplary embodiment of the present invention, a left half-rounded notch 32L is disposed along an interior surface of the left hose mount 12L and a right half-rounded notch 32R is disposed along an interior surface of the right hose mount 12R (see FIG. 5). The skilled person will appreciate that the gripping structure provided by the left half-rounded notch 32L and the right half-rounded notch 32R may have different configurations and/or cross sections in different exemplary embodiments of the present invention. Moreover, the shape of a cross-section of the notches is not an essential feature of the present invention. The left half-rounded notch 32L and the right half-rounded notch 32R allow a hose such as a suction hose to be securely clamped between the left hose mount 12L and the right hose mount 12R.

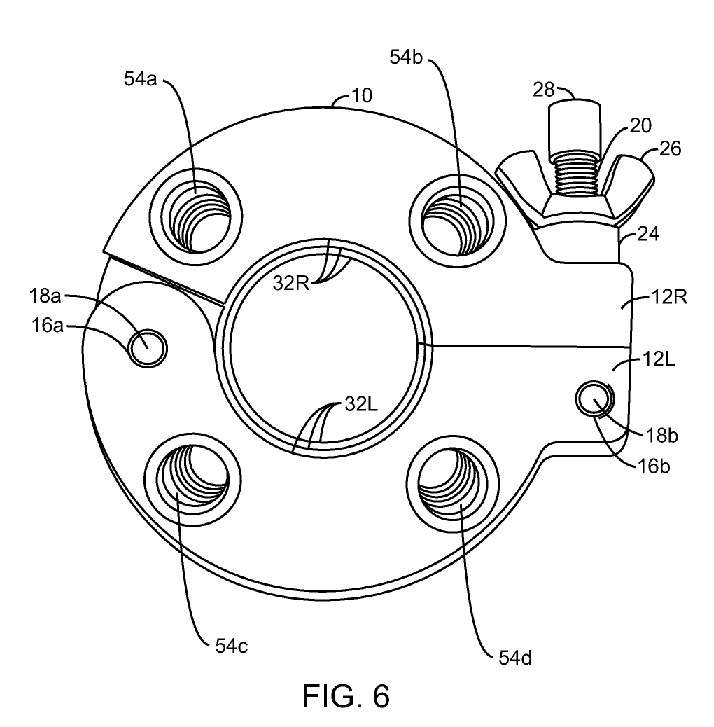

The device 10 includes four legs that support the assembly formed by the left hose mount 12L and the right hose mount 12R above the ground or water surface when in use. In the exemplary embodiment shown in FIG. 1, each leg comprises an elongated cylindrical rod 48. The elongated cylindrical rods 48 are adapted to be secured in one of a plurality of threaded holes 54a, 54b, 54c or 54d (see FIG. 6) in the hose mounts via a threaded end 52. The distal ends of the elongated cylindrical rods 48 are adapted to have a ball member 40 secured thereto via a socket bolt 38. Moreover, the socket bolts 38 may pass through their respective ball members 40 and engage a threaded bolt cavity 46 of the elongated cylindrical rods 48. The ball members 40 may provide stability when the device 10 is in use by preventing the device from sinking into soggy sediment or the like. In one exemplary embodiment of the present invention, each of the elongated cylindrical rods 48 includes a double-sided flat notch 50 adjacent to the hose mounts 12L and 12R when engaged therewith.

FIG. 2 is a perspective view in partial cross-section of a device for preventing intrusion of debris into a pump according to an exemplary embodiment of the present invention. In FIG. 2, the wing nut 26 is shown in dashed lines in its fully tightened position.

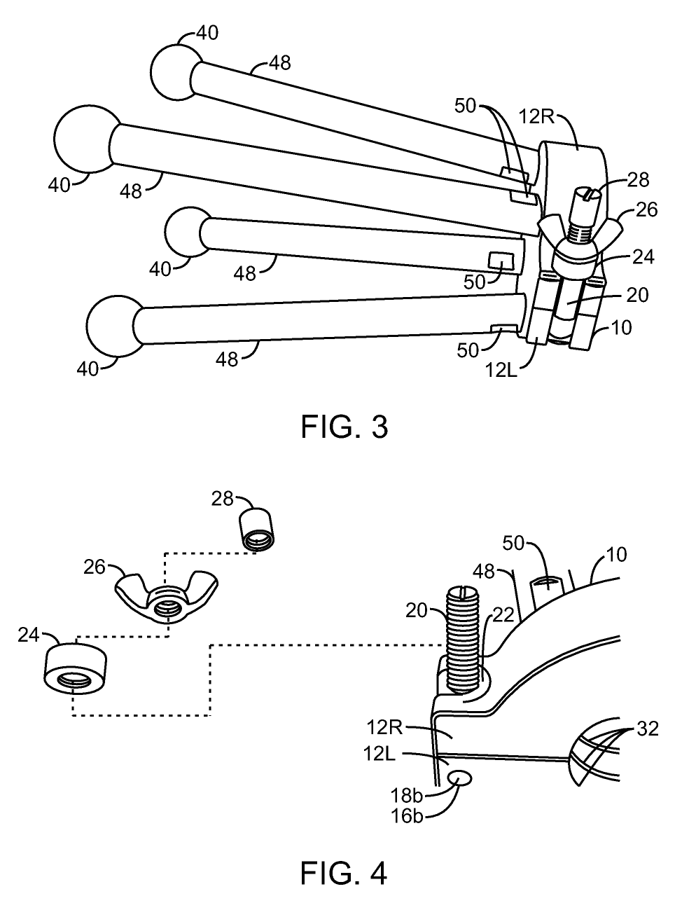

FIG. 3 is a perspective view of a device for preventing intrusion of debris into a pump, the device including a swing bolt according to an exemplary embodiment of the present invention.

FIG. 4 is an exploded view showing the use of a swing bolt according to an exemplary embodiment of the present invention.

FIG. 5 is a perspective view of a device for preventing intrusion of debris into a pump, the device including left and right hose mounts according to an exemplary embodiment of the present invention. In FIG. 5, the left hose mount 12L and the right hose mount 12R are shown in an open position. In the exemplary embodiment of the present invention shown in FIG. 5, a triangular indention 34 is formed in the left hose mount 12L. A triangular protrusion 36 on the right hose mount 12R is intended to help align the left hose mount 12L and the right hose mount 12R when they are closed together. Moreover, the triangular protrusion 36 is adapted to engage the triangular indention 34 when the left hose mount 12L and the right hose mount 12R are in the closed position.

FIG. 6 is a top view of left and right hose mounts according to an exemplary embodiment of the present invention. In FIG. 6, the left hose mount 12L and the right hose mount 12R are shown in the closed position.

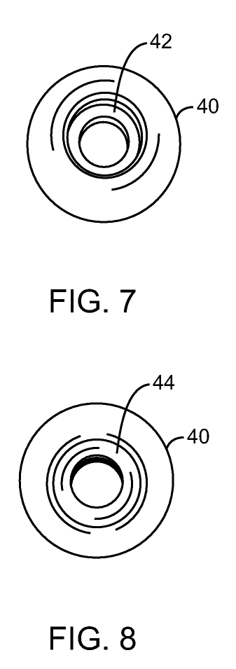

FIG. 7 is a top view of a ball member having a recessed bolt cavity according to an exemplary embodiment of the present invention. The ball member 40 comprises a recessed bolt cavity 42 that is adapted to engage the head of one of the socket bolts 38.

FIG. 8 is a bottom view of a ball member having a circular recessed ball mount according to an exemplary embodiment of the present invention. The ball member 40 comprises a recessed ball mount 44 that is adapted to engage with one end of one of the elongated cylindrical rods 48.

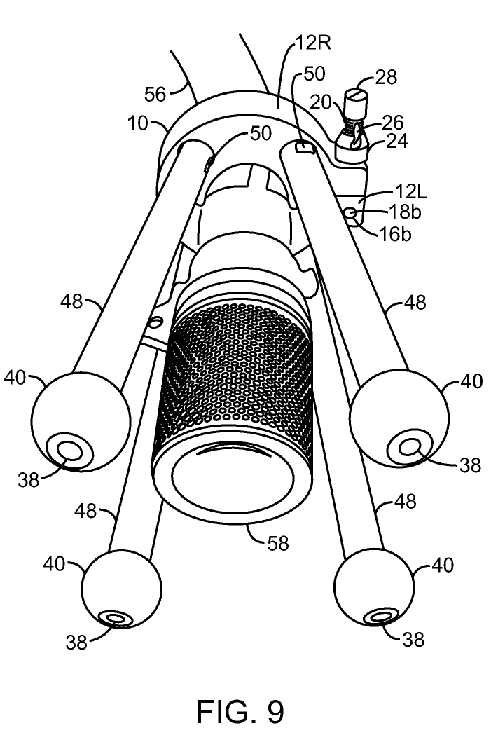

FIG. 9 is a perspective view of a device for preventing intrusion of debris into a pump according to an exemplary embodiment of the present invention. In FIG. 9, the device 10 is shown in use. A hose 56 is secured between the left hose mount 12L and the right hose mount 12R. The hose may be connected to a centrifugal pump to provide water thereto via suction through a foot valve 58.

To place the device 10 in operation, a user may hold the left hose mount 12L in the user's left hand. When holding the device 10, the ball members 40 may be positioned away from the user's body. With their right hand, the user may loosen the wing nut 26 until it contacts the cap 28. The user may then open the device by moving the swing bolt 20 downward until it is clear of the right hose mount 12R. The user then grips the right hose mount 12R and swings open the hinge 14R leaving the left hinge 14L in a stationary position. The user may then pick up the hose 56 and secure it between the left hose mount 12L and the right hose mount 12R. The foot valve 58 is desirably positioned so that it does not extend further than the ball members 40. This is to maintain the position of the foot valve at a desirable location relative to a water source without being pumped when the legs are placed in sediment. In one exemplary embodiment of the present invention, the left hose mount 12L and the right hose mount 12R are desirably not secured to a suction hose collar that may be connected to the foot valve 58.

The left half-rounded notch 32L (see FIG. 6) and the right half-rounded notch 32R are adapted to grip the hose 56 to keep the left hose mount 12L and the right hose mount 12R stationary. The user may close the right hose mount 12R toward the left hose mount 12L with the right hand. The triangular indention 34 will align and house the triangular protrusion 36 (see FIG. 5). The user may use the right hand to move the spacer 24 upward toward the wing nut 26. Thereafter, the user may move the swing bolt 20 upward into the grooves 30. The user may then release the spacer 24 toward the spacer indention 22 and tighten the wing nut 26 toward the spacer 24.

In one exemplary embodiment of the present invention, the user may attach a duplicate device 10 to the middle of the suction hose. The elongated cylinder rods 48 may be positioned toward the pump (i.e., opposite the foot valve. This helps to reduce swaying of the hose 56 because of water pressure. The user may lift the suction hose with both of the devices 10 and place it into the water.

The skilled person will appreciate that different materials, coatings, sizes and interconnections may be used in different exemplary embodiments of the present invention depending on specific design criteria for given applications.

As set forth herein, an exemplary embodiment of the present invention may improve the performance of firefighters by holding a foot valve of a centrifugal pump in a secure position and preventing the intrusion of debris. Moreover, exemplary embodiments of the present invention may reduce sway of suction hoses in field conditions.

What is claimed is:

1. A device for securing an inlet of a pump, the device comprising:
at least two hose mounts connected to each other;
a securing mechanism that is adapted to secure a hose between the at least two hose mounts, the hose comprising the inlet of the pump; and
a plurality of legs extending from the at least two hose mounts, the legs being adapted to hold the inlet in a fixed position relative to a source of water.

2. The device recited in claim 1, wherein the at least two hose mounts are connected by at least one hinge.

3. The device recited in claim 1, wherein the securing mechanism comprises a wing nut that engages a swing bolt to secure the hose between the at least two hose mounts.

4. The device recited in claim 3, wherein the swing bolt is securely affixed to a one of the at least two hose mounts and is adapted to engage another of the at least two hose mounts via a groove.

5. The device recited in claim 1, wherein each of the at least two hose mounts comprises a gripping structure that is adapted to securely grip the hose.

6. The device recited in claim 5, wherein the gripping structure comprises a half-rounded notch.

7. The device recited in claim 1, comprising a ball member secured to an end of each of the plurality of legs.

8. The device recited in claim 1, wherein the at least two hose mounts comprise an alignment structure.

9. The device recited in claim 8, wherein the alignment structure comprises a triangular protrusion disposed on a one of the at least two hose mounts, the triangular protrusion being adapted to engage with a triangular indention located on another of the at least two hose mounts.

10. The device recited in claim 1, wherein the inlet comprises a foot valve of a centrifugal pump.

11. A device for securing an inlet of a pump, the device comprising:
means for mounting a hose, the hose comprising the inlet of the pump;
means for securing the hose via the means for mounting; and
means for securing a position of the inlet of the pump, the means for securing extending from the at least two hose mounts, the means for securing being adapted to hold the inlet in a fixed position relative to a source of water.

12. The device recited in claim 11, wherein the means for mounting comprises at least two hose mounts connected by at least one hinge.

13. The device recited in claim 11, wherein the means for securing comprises a wing nut that engages a swing bolt to secure the hose via the means for mounting.

14. The device recited in claim 13, wherein the swing bolt is securely affixed to a one of at least two hose mounts and is adapted to engage another of the at least two hose mounts via a groove.

15. The device recited in claim 11, wherein the means for mounting comprises a gripping structure that is adapted to securely grip the hose.

16. The device recited in claim 15, wherein the gripping structure comprises a half-rounded notch.

17. The device recited in claim 11, wherein the means for securing the position comprises a plurality of legs, each having a ball member secured to an end thereof.

18. The device recited in claim 11, wherein the means for mounting comprises an alignment structure.

19. The device recited in claim 18, wherein the alignment structure comprises a triangular protrusion disposed on a one of at least two hose mounts, the triangular protrusion being adapted to engage with a triangular indention located on another of the at least two hose mounts.

20. The device recited in claim 11, wherein the inlet comprises a foot valve of a centrifugal pump.
